(19) United States
(12) Patent Application Publication
(10) Pub. No.: US 2024/0001480 A1
(43) Pub. Date: Jan. 4, 2024

(54) MULTI-PIN FRICTION STIR WELDING TOOL

(71) Applicants: Seyed hassan Nourbakhsh shorabi, shahrekord (IR); Mohammad amin Shahrokhian dehkordi, Karaj (IR); Mohammad Solati karchegani, Isfahan (IR)

(72) Inventors: Seyed hassan Nourbakhsh shorabi, shahrekord (IR); Mohammad amin Shahrokhian dehkordi, Karaj (IR); Mohammad Solati karchegani, Isfahan (IR)

(73) Assignees: Seyed hassan Nourbakhsh shorabi, shahrekord, OT (IR); Mohammad amin Shahrokhian dehkordi, Karaj, OT (IR); Mohammad Solati karchegani, Isfahan, OT (IR)

(21) Appl. No.: 18/346,826

(22) Filed: Jul. 4, 2023

Related U.S. Application Data
(63) Continuation-in-part of application No. PCT/IB2021/060783, filed on Nov. 21, 2021.
(60) Provisional application No. 63/133,429, filed on Jan. 4, 2021.

(51) Int. Cl. B23K 20/12

(52) U.S. Cl. CPC B23K 20/1255; B23K 20/125

(57) ABSTRACT

A double-pin friction stir device may include an annular friction surface with a central hole, where the annular friction surface is rotatable about a normal axis of the annular friction surface in a first direction. The device may further include a first pin extending through the central hole along a normal axis of the annular friction surface. A distal end of the first pin may protrude from the annular friction surface and the first pin may rotate about a longitudinal axis of the first pin in the first direction. The device may further include a second pin extending through the central hole along and parallel with the first pin, where a distal end of the second pin protrudes from the annular friction surface. The second pin rotates about a longitudinal axis of the second pin in a second direction opposite the first direction.

### CROSS-REFERENCE TO RELATED APPLICATION

This application is a continuation-in-part of International Application NO. PCT/IB2021/060783, filed Nov. 21, 2021, and entitled “MULTI-PIN FRICTION STIR WELDING TOOL” which claims the benefit of priority from U.S. Provisional Patent Application Ser. No. 63/133,429, filed on Jan. 4, 2021, and entitled “DOUBLE-PIN AND ONE-SHOULDER ROTATING MACHINE USING A PROPULSION FOR FRICTION STIR WELDING,” which are both incorporated herein by reference in their entirety.

### TECHNICAL FIELD

The present disclosure relates to friction stir welding and particularly relates to dual-rotation friction stir welding. More particularly, the present disclosure relates to a dual-rotation friction stir welding apparatus with double rotating pins and a single rotating shoulder.

### BACKGROUND

Friction stir welding (FSW) is a solid-state joining process that may be used to join two discrete metal workpieces that abut on a joint line. A basic rotary FSW may be performed utilizing a rotating cylindrical tool with a pin protruding from a base end of the rotating cylindrical tool. The protruding pin extending coaxially with the rotating cylindrical tool may have a diameter smaller than that of the rotating cylindrical tool, thereby defining a shoulder. During a welding process, the protruding pin may penetrate the two workpieces at the joint line between the two workpieces, so that the tool shoulder may contact the surface of the two workpieces. Then, the rotating cylindrical tool may be moved along the joint line while the tool shoulder rides on the surface of the two workpieces. The frictional heat generated between the rotating cylindrical tool and the workpiece material may soften an area on the two workpieces near the rotating cylindrical tool. As the rotating cylindrical tool moves along the joint line, the rotating cylindrical tool mechanically intermixes the two metal workpieces. Hot and softened materials of the two metal workpieces may be forged by a mechanical pressure applied utilizing the rotating cylindrical tool. FSW may be utilized to join aluminum alloys, thick copper material, and steel products.

FSW may have a number of variants, such as twin FSW, skew FSW, and dual-rotation FSW. In twin FSW, two or more contrarotating FSW tools may act on opposite sides of a workpiece to apply a double-sided welding operation, which may reduce the reactive torque and may provide a more symmetrical weld. The twin FSW may have three variants, namely, a parallel contrarotating variant, a tandem contrarotating variant, and a staggered variant. A skew FSW may include an FSW tool that may act on workpieces with an inclined axis relative to an axis of machine spindle. Finally, in a dual-rotation FSW, the pin and the shoulder rotate independently and as a result a dual-rotation FSW may allow for a differential in speed and rotational direction between the pin and the shoulder. Such independent rotation of the pin and shoulder in a dual-rotation FSW may allow for a high probe rotational speed without a corresponding increase in the circumferential speed of the shoulder, which helps prevent overheating or melting along the near shoulder side of the weld, while maintaining a higher rotational speed for the pin.

FSW may have several advantages over conventional fusion welding methods, such as higher mechanical strength and no re-solidification defects. However, in an FSW process performed by any of the aforementioned variants, certain defects like worm hole, lack of penetration, and kissing bond may occur. Consequently, there is a need for improving FSW techniques to eliminate such defects and gain refinement.

### SUMMARY

This summary is intended to provide an overview of the subject matter of the present disclosure and is not intended to identify essential elements or key elements of the subject matter, nor is it intended to be used to determine the scope of the claimed implementations. The proper scope of the present disclosure may be ascertained from the claims set forth below in view of the detailed description and the drawings.

According to one or more exemplary embodiments, present disclosure is directed to a double-pin friction stir device. An exemplary device may include an annular tool including an annular friction surface with a central hole. In an exemplary embodiment, the annular tool may include a hollow cylinder with an annular ring-shaped cross section. In an exemplary embodiment, the annular friction surface may include an annular ring-shaped bottom surface of the hollow cylinder. In an exemplary embodiment, the annular friction surface may be configured to rotate about a normal axis of the annular friction surface in a first direction by transferring a rotational movement of a spindle to the annular friction surface. In an exemplary embodiment, the double-pin friction stir device may further include a first pin with a rod-shape that may extend through the central hole along the normal axis of the annular friction surface. In an exemplary embodiment, a distal end of the first pin may be protruded from they annular friction surface. In an exemplary embodiment, the first pin may be configured to rotate about a longitudinal axis of the first pin in the first direction by transferring the rotational movement of the spindle to the first pin. In an exemplary embodiment, the double-pin friction stir device may further include a second pin with a rod-shape that may extend through the central hole along and parallel with the first pin, where a distal end of the second pin may be protruded from the annular friction surface. In an exemplary embodiment, the second pin may be configured to rotate about a longitudinal axis of the second pin in a second direction by transferring the rotational movement of the spindle to the second pin. In an exemplary embodiment, the second direction may be opposite the first direction.

In an exemplary embodiment, the distal end of the first pin and the distal end of the second pin may protrude from the annular friction surface by a similar distance.

In an exemplary embodiment, the double-pin friction stir device may further include a drive shaft extended along the longitudinal axis of the first pin between a first end of the drive shaft and a second opposing end of the drive shaft. In an exemplary embodiment, the first end of the drive shaft may be attached to an opposing proximal end of the first pin. In an exemplary embodiment, the second end of the drive shaft may be coupled to the spindle. In an exemplary embodiment, the drive shaft may transfer a rotational movement of the spindle to the first pin about the longitudinal axis of the first pin in the first direction.

In an exemplary embodiment, the double-pin friction stir device may further include a secondary shaft extended parallel with the drive shaft. In an exemplary embodiment, the secondary shaft may be coupled to the drive shaft utilizing a first spur gear set. In an exemplary embodiment, the drive shaft may further transfer a rotational movement of the spindle to the secondary shaft about a longitudinal axis of the secondary shaft in the first direction. In an exemplary embodiment, the secondary shaft may further coupled with the second pin via a second spur gear set. In an exemplary embodiment, the secondary shaft may drive a rotational movement of the second pin about the longitudinal axis of the second pin in the second direction.

In an exemplary embodiment, the secondary shaft may be further coupled with the annular friction surface utilizing a third spur gear set. In an exemplary embodiment, the secondary shaft may further drive a rotational movement of the annular friction surface about the normal axis of the annular friction surface in the second direction.

In an exemplary embodiment, the first spur gear set may include a first spur gear mounted on the drive shaft, a second spur gear mounted on the secondary shaft, and a middle gear mounted on an auxiliary shaft. In an exemplary embodiment, the first spur gear may be rotatable with the drive shaft in the first direction. In an exemplary embodiment, the second spur gear may be rotatable with the secondary shaft. In an exemplary embodiment, the auxiliary shaft may extend along and parallel with the drive shaft. In an exemplary embodiment, the middle gear may be rotatable with the auxiliary shaft about a longitudinal axis of the auxiliary shaft. In an exemplary embodiment, the middle gear may be meshed with both the first spur gear and the second spur gear. In an exemplary embodiment, the middle gear may transfer the rotational movement of the first spur gear to the second spur gear.

In an exemplary embodiment, the second spur gear set may include a third spur gear mounted on the secondary shaft and a fourth spur gear meshed with the third spur gear. In an exemplary embodiment, the third spur gear may be rotatable with the secondary shaft in the first direction. In an exemplary embodiment, the third spur gear may rotate the fourth spur gear in the second direction. In an exemplary embodiment, the fourth spur gear may be coupled to the second pin. In an exemplary embodiment, the fourth gear may drive a rotational movement of the second pin about the longitudinal axis of the second pin in the second direction.

In an exemplary embodiment, the fourth gear may be mounted on the drive shaft via a first bearing unit. In an exemplary embodiment, the first bearing unit may allow the drive shaft to rotatably pass through the fourth spur gear. In an exemplary embodiment, the third spur gear may be spaced apart from the second spur gear along the longitudinal axis of the secondary shaft.

In an exemplary embodiment, the third spur gear set may include a fifth spur gear mounted on the secondary shaft and a sixth spur gear meshed with the fifth spur gear. In an exemplary embodiment, the fifth spur gear may be rotatable with the secondary shaft in the first direction. In an exemplary embodiment, the fifth spur gear may be spaced apart from the third spur gear along the longitudinal axis of the secondary shaft. In an exemplary embodiment, the sixth spur gear may be rotatable in the second direction. In an exemplary embodiment, the sixth spur gear may be attached to and coaxially rotatable with the annular friction surface.

In an exemplary embodiment, the annular tool may be coupled with the sixth spur gear. In an exemplary embodiment, the annular tool may be rotatable with the sixth spur gear in the second direction.

In an exemplary embodiment, the second pin may be coupled with the fourth spur gear utilizing a coupling mechanism. In an exemplary embodiment, the coupling mechanism may include a driver wheel coupled and rotatable with the fourth spur gear, a driven wheel comprising a slider attached to the second pin, and a middle member coupled between the driver wheel and the driven wheel.

In an exemplary embodiment, the driver wheel may include a first groove and a second groove. In an exemplary embodiment, the first groove and the second groove may extend parallel with each other along an axis perpendicular to the normal axis of the fourth spur gear.

In an exemplary embodiment, the middle member may transfer the rotational motion of the driver wheel to the driven wheel. In an exemplary embodiment, the middle member may include a first U-shaped part comprising a first extended tongue slidably disposed within the first groove and a second extended tongue slidably disposed within the second groove, a second U-shaped part attached to the first U-shaped part, and a third U-shaped part attached to the first U-shaped part. In an exemplary embodiment, the second U-shaped part may include a first slot perpendicular to the first extended tongue. In an exemplary embodiment, the third U-shaped part may include a second slot perpendicular to the second extended tongue. In an exemplary embodiment, the first slot may align with the second slot and form an elongated slot. In an exemplary embodiment, the elongated slot may be perpendicular to the first groove and the second groove. In an exemplary embodiment, the slider may be slidably disposed within the elongated slot.

In an exemplary embodiment, the double-pin friction stir device may further include a first support wall including a first hole fitted with a second bearing unit, a second hole fitted with a third bearing unit, and a third hole fitted with a fourth bearing unit. In an exemplary embodiment, the drive shaft may rotatably pass through the first hole leaning on the second bearing unit. In an exemplary embodiment, the secondary shaft may rotatably pass through the second hole leaning on the third bearing unit. In an exemplary embodiment, the auxiliary shaft may rotatably pass through the third hole leaning on the fourth bearing unit.

In an exemplary embodiment, the double-pin friction stir device may further include a second support wall parallel with the first support wall. In an exemplary embodiment, the second support wall may be spaced apart from the first support wall along the longitudinal axis of the drive shaft. In an exemplary embodiment, the second support wall may include a fourth hole fitted with a fifth bearing unit, a fifth hole fitted with a sixth bearing unit, and a sixth hole fitted with a seventh bearing unit. In an exemplary embodiment, the drive shaft may rotatably pass through the fourth hole leaning on the fifth bearing unit. In an exemplary embodiment, the secondary shaft may rotatably pass through the fifth hole leaning on the sixth bearing unit. In an exemplary embodiment, the auxiliary shaft may rotatably pass through the sixth hole leaning on the seventh bearing unit.

In an exemplary embodiment, the double-pin friction stir device may further include a third support wall parallel with the second support wall. In an exemplary embodiment, the third support wall may be spaced apart from the second support wall along the longitudinal axis of the drive shaft. In an exemplary embodiment, the third support wall may include a seventh hole and an eighth hole fitted with an eighth bearing unit. In an exemplary embodiment, the secondary shaft may rotatably pass through the eighth hole leaning on the eighth bearing unit. In an exemplary embodiment, the first pin and the second pin may rotatably pass through the seventh hole. In an exemplary embodiment, the seventh hole may be aligned with the central hole of the annular friction surface along the normal axis of the annular friction surface.

In an exemplary embodiment, the first spur gear set may be disposed between the first support wall and the second support wall. In an exemplary embodiment, the second spur gear set may be disposed between the third support wall and the second support wall.

In an exemplary embodiment, the seventh hole may include an annular lip extended perpendicular to the third support wall. In an exemplary embodiment, the seventh spur gear may be rotatably mounted on the annular lip.

### BRIEF DESCRIPTION OF THE DRAWINGS

The novel features which are believed to be characteristic of the present disclosure, as to its structure, organization, use and method of operation, together with further objectives and advantages thereof, will be better understood from the following drawings in which a presently exemplary embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1 illustrates a schematic of a double-pin friction stir device, consistent with one or more exemplary embodiments of the present disclosure;

FIG. 2 illustrates an exemplary double-pin friction stir device utilized for friction stir welding of two workpieces, consistent with one or more exemplary embodiments of the present disclosure;

FIG. 3A illustrates a perspective view of a double-pin friction stir apparatus, consistent with one or more exemplary embodiments of the present disclosure;

FIG. 3B illustrates a sectional perspective view of a double-pin friction stir apparatus, consistent with one or more exemplary embodiments of the present disclosure;

FIG. 4A illustrates a sectional top view of a coupling mechanism between a fourth spur gear and a second pin, consistent with one or more exemplary embodiments of the present disclosure; and

FIG. 4B illustrates an exploded perspective view of a coupling mechanism between a fourth spur gear and a second pin, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

The present disclosure is directed to exemplary embodiments of a system and method for dual-rotation double-pin friction stir welding. An exemplary system for friction stir welding may include two contrarotating pins and a single rotating shoulder provided by an annular tool. Exemplary pins may assume rotational motions about their respective longitudinal axes while an exemplary shoulder may rotate about a longitudinal axis of an exemplary annular tool. An exemplary annular tool and exemplary pins may be coupled to an actuation mechanism that may allow for driving all the rotational movements of exemplary pins and exemplary shoulder by utilizing a single spindle.

Exemplary pins may protrude from an exemplary shoulder by a similar distance along a longitudinal axis of an exemplary annular tool. An exemplary longitudinal axis of an exemplary first pin of exemplary pins may be parallel with an exemplary longitudinal axis of an exemplary second pin of exemplary pins with a small offset between the aforementioned exemplary longitudinal axes. Such configuration of the two exemplary pins and an exemplary single shoulder may allow for performing a friction stir welding process in a contrarotating friction stir welding process with either parallel or tandem configurations.

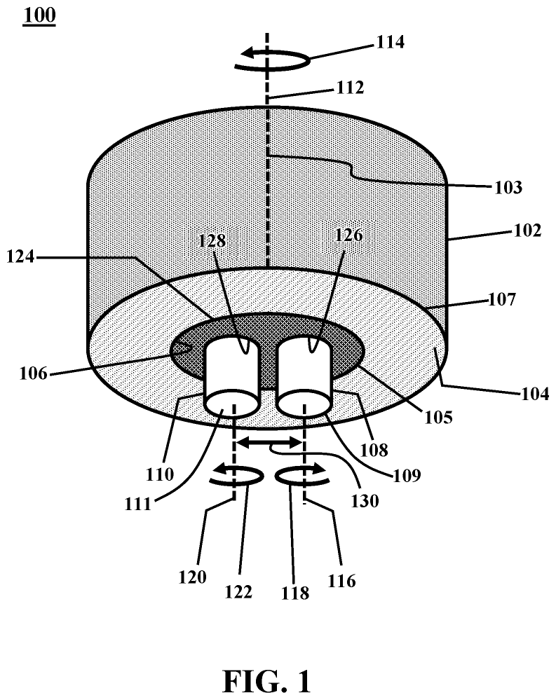

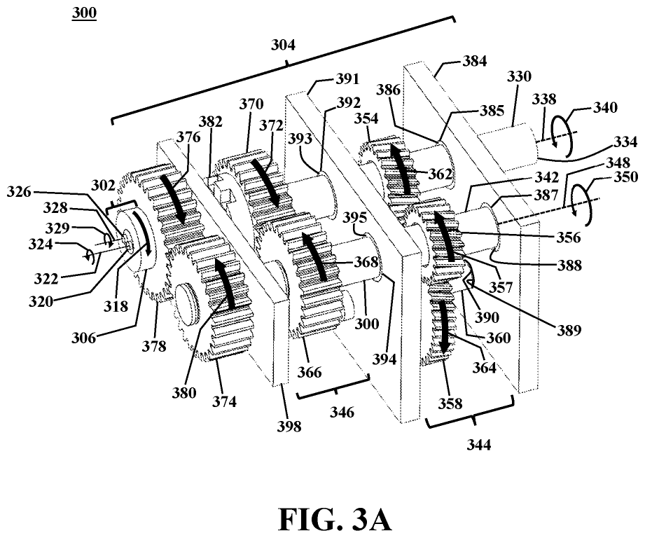

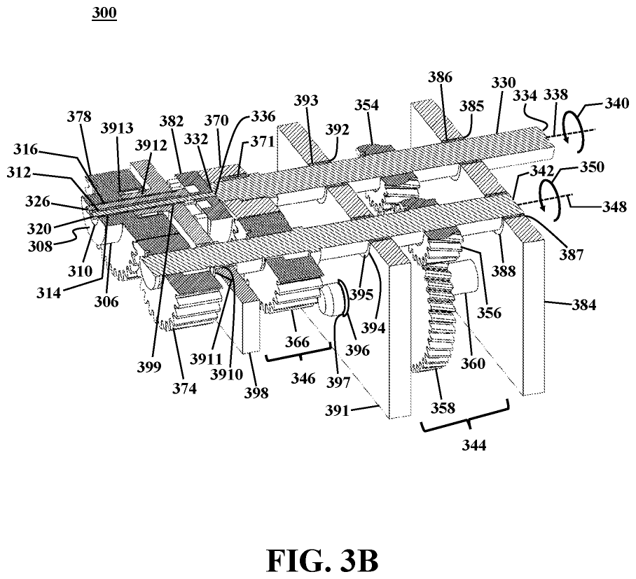

FIG. 1 illustrates a schematic of a double-pin friction stir device 100, consistent with one or more exemplary embodiments of the present disclosure. In an exemplary embodiment, double-pin friction stir device 100 may be utilized as an end-effector in a friction stir welding (FSW) process. In an exemplary embodiment, double-pin friction stir device 100 may include an annular tool 102 that may provide an annular friction surface 104. In an exemplary embodiment, annular tool 102 may include an annular cylinder (or a hollow cylinder) with a ring-shaped cross section. In an exemplary embodiment, an exemplary ring-shaped cross section may include a surface bounded between two concentric circles, including a first inner circle of an inner wall of an exemplary annular cylinder and a second outer circle of an outer wall of an exemplary annular cylinder. In an exemplary embodiment, annular tool 102 may include annular friction surface 104, that is, one end cross section (i.e., a bottom or a top base/surface) of annular tool 102 bounded between two concentric circles 105 and 107. In an exemplary embodiment, two concentric circles 105 and 107 may include a first inner circle 105 of an inner wall of annular tool 102 and a second outer circle 107 of an outer wall of annular tool 102. In an exemplary embodiment, annular tool 102 may include a central hole 106 that may extend along annular tool 102 with open ends on annular friction surface 104 and the other opposing base end of annular tool 102. In an exemplary embodiment, central hole 106 may extend along a normal axis 112 of annular friction surface 104 with a cross-section of central hole 106 being parallel with annular friction surface 104. As used herein, normal axis 112 of annular friction surface 104 may refer to an axis perpendicular to annular friction surface 104 and passing through the center of annular friction surface 104. In an exemplary embodiment, normal axis 112 of annular friction surface 104 may be aligned and parallel with a longitudinal axis 103 of annular tool 102. In an exemplary embodiment, annular tool 102 may be configured to rotate about normal axis 112 of annular friction surface 104 in a first direction, that is, annular tool 102 may be attached to or integrally formed with an actuation assembly similar to actuation assembly 304 of FIGS. 3A and 3B described herein below; allowing for transferring a rotational motion of a spindle coupled to an exemplary actuation assembly to annular tool 102. For simplicity, actuation mechanisms that may be utilized for driving such rotational motion of annular tool 102 are not illustrated in FIG. 1. In an exemplary embodiment, the first direction may be either clockwise or counterclockwise, for example, a counterclockwise first direction is shown by arrow 114.

In an exemplary embodiment, double-pin friction stir device 100 may further include a first pin 108 that may extend through central hole 106 along normal axis 112 of annular friction surface 104. In an exemplary embodiment, a distal end 109 of first pin 108 may protrude from annular friction surface 104 along normal axis 112. In an exemplary embodiment, first pin 108 may be configured to rotate about a longitudinal axis 116 of first pin 108 in a second direction, that is, first pin 108 may be coupled to an exemplary actuation assembly similar to actuation assembly 304 of FIGS. 3A and 3B described herein below; allowing for transferring a rotational motion of an exemplary spindle coupled to an exemplary actuation assembly to first pin 108. For simplicity, actuation mechanisms that may be utilized for driving such rotational motion of first pin 108 are not illustrated in FIG. 1. In an exemplary embodiment, the second direction may either be clockwise or counterclockwise, for example, a clockwise second direction is shown by arrow 118.

In an exemplary embodiment, double-pin friction stir device 100 may further include a second pin 110 that may extend through central hole 106 along normal axis 112 of annular friction surface 104. In an exemplary embodiment, a distal end 111 of second pin 110 may protrude from annular friction surface 104 along normal axis 112. In an exemplary embodiment, second pin 110 may be configured to rotate about a longitudinal axis 120 of second pin 110 in a third direction, that is, second pin 110 may be coupled to an exemplary actuation assembly similar to actuation assembly 304 of FIGS. 3A and 3B described herein below; allowing for transferring a rotational motion of an exemplary spindle coupled to an exemplary actuation assembly to second pin 110. For simplicity, actuation mechanisms that may be utilized for driving such rotational motion of second pin 110 are not illustrated in FIG. 1. In an exemplary embodiment, the third direction may be opposite the second direction using a set of spur gears intermeshing together in an exemplary actuation assembly. For example, responsive to the second direction being clockwise as shown by arrow 118, the third direction may be counterclockwise as shown by arrow 122. In an exemplary embodiment, each pin of first pin 108 and second pin 110 may have a rod-shape. In an exemplary embodiment, each pin of first pin 108 and second pin 110 may have a sharp tip.

In an exemplary embodiment, second pin 110 may extend parallel with first pin 108 with a distance 130 between longitudinal axis 116 of first pin 108 and longitudinal axis 120 of second pin 110. In an exemplary embodiment, first direction 114 and third direction 122 may be similar. In other words, annular tool 102 and second pin 110 may be configured to rotate about their respective longitudinal axes in the same direction, while first pin 108 may be configured to rotate in an opposite direction, which may be described in detail herein below in connection with FIGS. 3A and 3B.

In an exemplary embodiment, double-pin friction stir device 100 may further include an annular sleeve 124 that may extend along central hole 106. In an exemplary embodiment, annular sleeve 124 may include a first elongated hole 126 and a second elongated hole 128. In an exemplary embodiment, first elongated hole 126 and second elongated hole 128 may be open-ended holes extended along normal axis 112 within annular sleeve 124. In an exemplary embodiment, first elongated hole 126 may house first pin 108 and second elongated hole 128 may house second pin 110. In an exemplary embodiment, such configuration of first elongated hole 126 and second elongated hole 128 of annular sleeve 124 may allow for maintaining first pin 108 and second pin 110 in position at distance 130 from each other. In other words, central hole 106 may be fitted with annular sleeve 124 and annular sleeve 124 may guide first pin 108 and second pin 110 through central hole 106. In an exemplary embodiment, first pin 108 may be rotatable within first elongated hole 126 and second pin 110 may be rotatable within second elongated hole 128. In an exemplary embodiment, first pin 108 may be rotatably secured within first elongated hole 126 and second pin 110 may be rotatably secured within second elongated hole 128.

In an exemplary embodiment, first pin 108 and second pin 110 may protrude from annular friction surface 104 by a similar distance. In other words, distal end 109 of first pin 108 and distal end 111 of second pin 110 may be aligned with each other on a plane parallel with annular friction surface 104. As used herein, two parallel planes or two parallel surfaces may refer to two planes or surfaces with their respective normal axes parallel with each other.

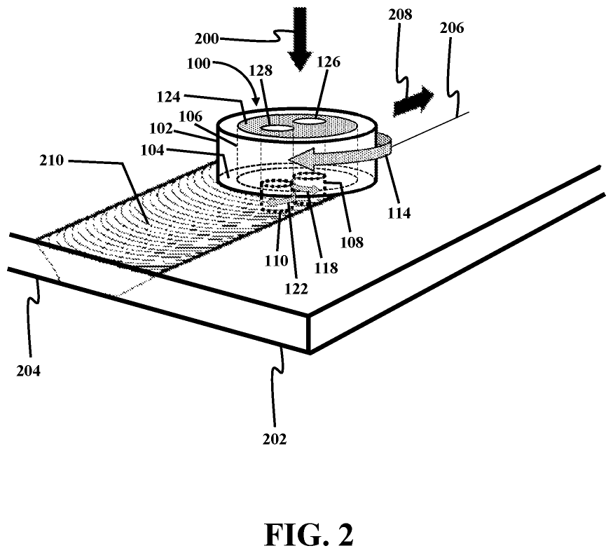

In an exemplary embodiment double-pin friction stir device 100 may be utilized for friction stir welding of two workpieces. FIG. 2 illustrates double-pin friction stir device 100 utilized for friction stir welding of two workpieces (202, 204), consistent with one or more exemplary embodiments of the present disclosure. In practice, two workpieces that are to be welded together, such as workpiece 202 and workpiece 204 may be placed side by side, such that workpiece 202 and workpiece 204 may contact each other on a common joint line 206. In an exemplary embodiment, first pin 108 and second pin 110 may be inserted into workpieces (202, 204) on joint line 206, such that annular friction surface 104 may be tangentially positioned on and contact the surface of workpieces (202, 204). In an exemplary embodiment, annular tool 102 may be rotated about a longitudinal axis of annular tool 102 in a first direction shown by arrow 114. Furthermore, first pin 108 may be configured to rotate about a longitudinal axis of first pin 108 in a second direction shown by arrow 118, and second pin 110 may be configured to rotate about a longitudinal axis of second pin 110 in a third direction shown by arrow 122. In an exemplary embodiment, annular tool 102, first pin 108, and second pin 110 may be rotated utilizing an exemplary actuation assembly similar to actuation assembly 304 of FIGS. 3A and 3B described herein below. For simplicity, actuation mechanisms, illustrated by arrow 200 that may be utilized for driving such rotational motion of annular tool 102, first pin 108, and second pin 110 are not illustrated in FIG. 2. In an exemplary embodiment, annular tool 102 and second pin 110 may rotate in a similar direction, while first pin 108 may rotate in an opposite direction, as illustrated by arrows (114, 118, and 122). In an exemplary embodiment, rotational motions of annular friction surface 104, first pin 108, and second pin 110 may cause friction, which in turn may generate heat and plastic deformation of workpieces (202, 204). In an exemplary embodiment, double-pin friction stir device 100 may be moved transversely along joint line 206 in a direction shown by arrow 208. Such transversal movement of double-pin friction stir device 100 as well as the heat generated by the friction may allow for joining workpieces (202, 204) along joint line 206. In an exemplary embodiment, as double-pin friction stir device 100 moves and welds workpieces (202, 204), a footprint 210 of the weld may remain as a strip on the surface of workpieces (202, 204) along joint line 206.

In an exemplary embodiment, first pin 108 and second pin 110 may have a tandem contrarotating configuration, which may refer to a configuration in which first pin 108 and second pin 110 rotate in opposite directions and second pin 110 moves following first pin 108 along welding direction shown by arrow 208. In an exemplary embodiment, an exemplary tandem contrarotating configuration may refer to a tandem placement and relationship between first pin 108 and second pin 110, in which, first pin 108 moves along joint line 206 in an exemplary direction of arrow 208 and second pin 110 moves afterwards while first pin 108 rotate along a clockwise or counterclockwise direction (e.g., an exemplary second direction shown by arrow 118), and simultaneously, second pin 110 rotate along an opposite direction to a rotation direction of first pin 108 (e.g., an exemplary third direction shown by arrow 122).

FIG. 3A illustrates a perspective view of a double-pin friction stir apparatus 300, consistent with one or more exemplary embodiments of the present disclosure. FIG. 3B illustrates a sectional perspective view of double-pin friction stir apparatus 300, consistent with one or more exemplary embodiments of the present disclosure. In an exemplary embodiment, double-pin friction stir apparatus 300 may include a double-pin friction stir device 302 that may be structurally similar to double-pin friction stir device 100 coupled to an actuation assembly 304. In an exemplary embodiment, actuation assembly 304 may be utilized to transfer a rotational motion of a spindle to double-pin friction stir device 302, as will be discussed herein below.

In an exemplary embodiment, a structure of double-pin friction stir device 302 may be similar to double-pin friction stir device 100. In an exemplary embodiment, double-pin friction stir device 302 may include an annular tool 306 similar to annular tool 102, which may provide an annular friction surface 308 similar to annular friction surface 104. In an exemplary embodiment, annular tool 306 may have a central hole 310 similar to central hole 106 that may be fitted with an annular sleeve 312 similar to annular sleeve 124. In an exemplary embodiment, annular sleeve 312 may include a first elongated hole 314 similar to first elongated hole 126 and a second elongated hole 316 similar to second elongated hole 128. In an exemplary embodiment, annular tool 306 may be configured to rotate about a longitudinal axis of annular tool 306 in a first direction shown by arrow 318, that is, annular tool 306 may be coupled to actuation assembly 304; allowing for transferring a rotational motion of an exemplary spindle coupled to an exemplary actuation assembly 304 to annular tool 306. In an exemplary embodiment, the first direction may be one of a clockwise direction or a counterclockwise direction. As an example, the first direction is considered to be clockwise as shown by arrow 318 in FIG. 3A.

In an exemplary embodiment, double-pin friction stir device 302 may further include a first pin 320 similar to first pin 108, where first pin 320 may be rotatably secured within first elongated hole 314. In an exemplary embodiment, first pin 320 may be configured to rotate about a longitudinal axis 322 of first pin 320 in a second direction shown by arrow 324, that is, first pin 320 may be coupled to actuation assembly 304; allowing for transferring a rotational motion of an exemplary spindle coupled to an exemplary actuation assembly 304 to first pin 320. In an exemplary embodiment, the second direction may be opposite the first direction. For example, if the first direction is clockwise, the second direction is counter-clockwise and if the first direction is counterclockwise the second direction is clockwise. As an example, referring to FIG. 3A, in response to annular tool 306 rotating in a clockwise direction as shown by arrow 318, first pin 320 may rotate in a counterclockwise direction as shown by arrow 324.

In an exemplary embodiment, double-pin friction stir device 302 may further include a second pin 326 similar to second pin 110, where second pin 326 may be rotatably secured within second elongated hole 316. In an exemplary embodiment, second pin 326 may be configured to rotate about a longitudinal axis 328 of second pin 326 in a third direction shown by arrow 329, that is, second pin 326 may be coupled to actuation assembly 304; allowing for transferring a rotational motion of an exemplary spindle coupled to an exemplary actuation assembly 304 to second pin 326. In an exemplary embodiment, the third direction may be opposite the second direction. For example, if the second direction is clockwise, the third direction is counter-clockwise and if the second direction is counterclockwise, the third direction is clockwise. As an example, referring to FIG. 3A, in response to first pin 320 rotating in a counterclockwise direction as shown by arrow 324, second pin 326 may rotate in a clockwise direction as shown by arrow 329.

In an exemplary embodiment, actuation assembly 304 may include a drive shaft 330 that may extend along longitudinal axis 322 of first pin 320 between a first end 332 of drive shaft 330 and a second opposing end 334 of drive shaft 330. In an exemplary embodiment, first end 332 of drive shaft 330 may be attached to or integrally formed with a proximal end 336 of first pin 320. In an exemplary embodiment, second end 334 of drive shaft 330 may be coupled to a spindle (not illustrated). In an exemplary embodiment, a spindle may be utilized for driving a rotational movement of drive shaft 330 about a longitudinal axis 338 of drive shaft 330 in the first direction, for example, the direction shown by arrow 340. In an exemplary embodiment, drive shaft 330 may then drive a rotational movement of first pin 320 about longitudinal axis 322 of first pin 320 in the first direction, as shown by arrow 324.

In an exemplary embodiment, actuation assembly 304 may further include a secondary shaft 342 that may extend parallel with drive shaft 330. In an exemplary embodiment, secondary shaft 342 may be coupled to drive shaft 330 utilizing a first spur gear set 344. In an exemplary embodiment, drive shaft 330 may further be configured to drive a rotational movement of secondary shaft 342 about a longitudinal axis 348 of secondary shaft 342 in the first direction, as shown by arrow 350. In an exemplary embodiment, secondary shaft 342 may further be coupled with second pin 326 via a second spur gear set 346. In an exemplary embodiment, secondary shaft 342 may be configured to drive a rotational movement of second pin 326 about longitudinal axis 328 of second pin 326 in the second direction, as shown by arrow 329.

In an exemplary embodiment, first spur gear set 344 may include a first spur gear 354 that may be mounted on drive shaft 330. In an exemplary embodiment, first spur gear 354 may be rotatable with drive shaft 330 in the first direction. In an exemplary embodiment, first spur gear set 344 may further include a second spur gear 356 that may be mounted on secondary shaft 342. In an exemplary embodiment, second spur gear 356 may be rotatable with secondary shaft 342. In an exemplary embodiment, first spur gear set 344 may further include a middle gear 358 that may be mounted on an auxiliary shaft 360. In an exemplary embodiment, auxiliary shaft 360 may extend along and parallel with drive shaft 330. In an exemplary embodiment, middle gear 358 may be rotatable with auxiliary shaft 360 about a longitudinal axis of auxiliary shaft 360. In an exemplary embodiment, middle gear 358 may mesh with both first spur gear 354 and second spur gear 356. In an exemplary embodiment, middle gear 358 may further transfer the rotational movement of first spur gear 354 to second spur gear 356, that is due, to meshing of middle gear 358 between first spur gear 354 and second spur gear 356.

In an exemplary embodiment, exemplary intermeshing of first spur gear 354, second spur gear 356, and middle spur gear 358 together, as described above, may allow for transferring the rotational movement of drive shaft 330 to secondary shaft 342 in the same direction. For example, in response to drive shaft 330 rotating in a counterclockwise direction as shown by arrow 340, first spur gear 354 may rotate in a counterclockwise direction as shown by arrow 362. Since middle gear 358 is meshed with first spur gear 354, responsive to counterclockwise rotation of first spur gear 354, middle gear 358 may assume a clockwise rotation as shown by arrow 364. The clockwise rotation of middle gear 358 may urge second spur gear 356 to assume a counterclockwise rotation as shown by arrow 357, which in turn, may force secondary shaft 342 to rotate in a counterclockwise direction as shown by arrow 350.

In an exemplary embodiment, second spur gear set 346 may include a third spur gear 366 that may be mounted on secondary shaft 342. In an exemplary embodiment, third spur gear 366 may be rotatable with secondary shaft 342 in the first direction, as shown by arrow 368. In an exemplary embodiment, third spur gear 366 may be spaced apart from second spur gear 356 along longitudinal axis 348 of secondary shaft 342. In an exemplary embodiment, second spur gear set 346 may further include a fourth spur gear 370 that may mesh with third spur gear 366. In an exemplary embodiment, third spur gear 366 may rotate fourth spur gear 370 in the second direction, as shown by arrow 372. In an exemplary embodiment, fourth spur gear 370 may be coupled to second pin 326 and may be configured to drive a rotational movement of second pin 326 about longitudinal axis 328 of second pin 326 in the second direction, as shown by arrow 328. In an exemplary embodiment, fourth gear 370 may be mounted on drive shaft 330 via a first bearing unit 372. In an exemplary embodiment, first bearing unit 371 may allow drive shaft 330 to rotatably pass through fourth spur gear 370. In other words, first bearing unit 371 may allow for drive shaft 330 to pass through fourth spur gear 370, while drive shaft 330 and fourth spur gear 370 may assume independent rotational motions in opposite directions.

In an exemplary embodiment, secondary shaft 342 may further be coupled with annular friction surface 308 utilizing a third spur gear set 352. In an exemplary embodiment, secondary shaft 342 may further drive a rotational movement of annular friction surface 308 about a normal axis of annular friction surface 308 in the second direction, as shown by arrow 318. In an exemplary embodiment, third spur gear set 352 may include a fifth spur gear 374 that may be mounted on secondary shaft 342. In an exemplary embodiment, fifth spur gear 374 may be rotatable with secondary shaft 342 in the first direction, as shown by arrow 376. In an exemplary embodiment, fifth spur gear 374 may be spaced apart from third spur gear 366 along longitudinal axis 348 of secondary shaft 342. In an exemplary embodiment, third spur gear set 352 may further include a sixth spur gear 378 that may mesh with fifth spur gear 374. In an exemplary embodiment, sixth spur gear 378 may be rotatable in the second direction, as shown by arrow 380. In an exemplary embodiment, sixth spur gear 378 may be attached to and coaxially rotatable with annular friction surface 308.

In an exemplary embodiment, annular tool 306 may be attached to or integrally formed with sixth spur gear 378, such that a plane of rotation of annular tool 306 may be parallel with a plane of rotation of sixth spur gear 378. In an exemplary embodiment, responsive to sixth spur gear 378 rotating in the second direction as shown by arrow 376, annular tool 306 may assume a rotational motion in the second direction as shown by arrow 318. In an exemplary embodiment, all the rotational directions shown by arrows (350, 362, 357, 364, 368, 372, 380, 376, 318, 324, and 328) are illustrated based on a counterclockwise rotation of drive shaft 320 as shown by arrow 340. In case, the rotational movement of drive shaft 320 changes direction, all the directions shown by arrows (350, 362, 357, 364, 368, 372, 380, 376, 318, 324, and 328) may also be reversed.

In an exemplary embodiment, second pin 326 may be coupled with fourth spur gear 370 via a coupling 382, where coupling 382 may transfer the rotational motion of fourth spur gear 370 about longitudinal axis 338 of drive shaft 330 to second pin 326, where second pin 326 may assume a rotational motion about longitudinal axis 328 of second pin 326. In an exemplary embodiment, since the axis of rotation of fourth spur gear 370 (i.e., longitudinal axis 338) is not aligned with an axis of rotation of second pin 326 (i.e., longitudinal axis 328), coupling 382 may transfer the rotational movement between the aforementioned two offset axes of rotation (328, 338).

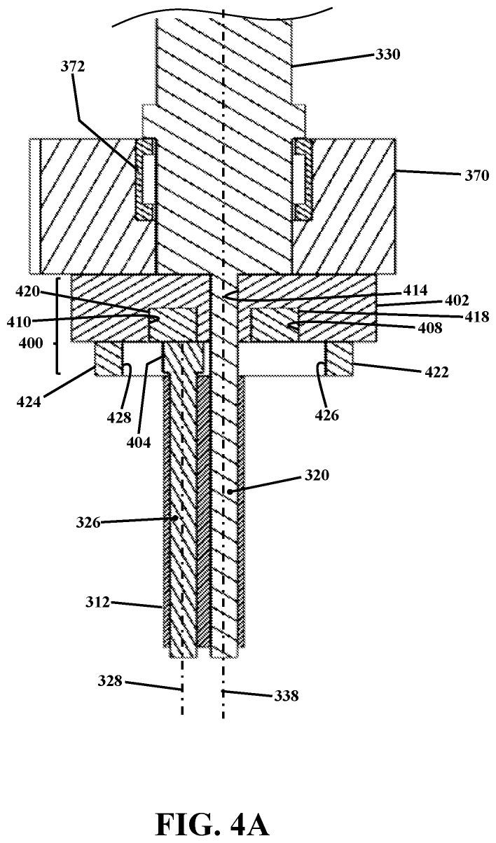

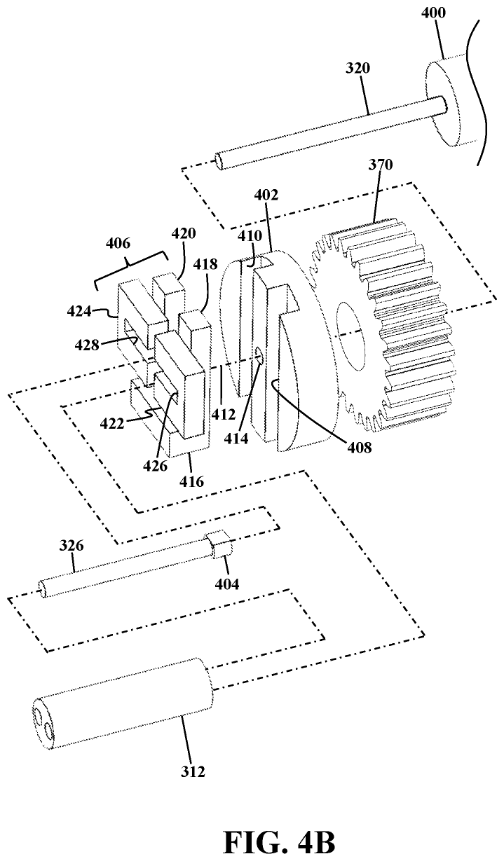

FIG. 4A illustrates a sectional top view of a coupling mechanism 400 between fourth spur gear 370 and second pin 326, consistent with one or more exemplary embodiments of the present disclosure. FIG. 4B illustrates an exploded perspective view of coupling mechanism 400 between fourth spur gear 370 and second pin 326, consistent with one or more exemplary embodiments of the present disclosure. In an exemplary embodiment, coupling mechanism 400 may be similar to coupling 382 and may transfer the rotational movement of fourth spur gear 370 to second pin 326.

In an exemplary embodiment, coupling mechanism 400 may be attached to and rotatable with fourth spur gear 370. In an exemplary embodiment, coupling mechanism 400 may include a driver wheel 402, a driven wheel 404, and a middle member 406 that may be coupled between driver wheel 402 and driven wheel 404. In an exemplary embodiment, driver wheel 402 may be an annular wheel that may be attached to and driven by fourth spur gear 370 with a plane of rotation of driver wheel 402 about longitudinal axis 338 being parallel with a plane of rotation of fourth spur gear 370 about longitudinal axis 338.

As mentioned before, in an exemplary embodiment, coupling mechanism 400 may transfer torque between fourth spur gear 370 and second pin 326, which rotate about two parallel but not collinear axes. In an exemplary embodiment, driver wheel 402 may be attached to or coupled with fourth spur gear 370, driven wheel 404 may be coupled to or integrally formed with second pin 326, and middle member 406 may be joined to driver wheel 402 and driven wheel 404 by tongue-and-groove connectors. In an exemplary embodiment, middle member 406 may be joined to driver wheel 402 from a first side of middle member 406 and middle member 406 may be joined to driven wheel 404 from a second opposing side of middle member 406 by utilizing a respective tongue-and-groove connector at either side of middle member 406. In an exemplary embodiment, the tongue-and-groove connector on the first side may be perpendicular to the tongue-and-groove connector on the second side, as will be discussed in the following paragraph.

In an exemplary embodiment, driver wheel 402 may include a first groove 408 and a second groove 410 that are parallel with each other. In an exemplary embodiment, first groove 408 and second groove 410 may extend along the plane of rotation of driver wheel 402 perpendicular to a normal axis 412. In an exemplary embodiment, driver wheel 402 may further include a central aperture 414 that may allow first pin 320 to pass through driver wheel 402.

In an exemplary embodiment, middle member 406 may include a first U-shaped part 416 with a first extended tongue 418 and a second extended tongue 420 that are parallel with each other. In an exemplary embodiment, first extended tongue 418 may be slidably disposed within first groove 408 and second extended tongue 420 may be slidably disposed within second groove 410. In an exemplary embodiment, middle member 406 may be coupled with driver wheel 402 by disposing first extended tongue 418 within first groove 408 and by further disposing second extended tongue 420 within second groove 410. In an exemplary embodiment, such configuration of first extended tongue 418 within first groove 408 and second extended tongue 420 within second groove 410 may form a tongue-and-groove connection between a first side of middle member 406 and driver wheel 402.

In an exemplary embodiment, middle member 406 may further include a second U-shaped part 422 and a third U-shaped part 424 that may be attached to or integrally formed with first U-shaped part 416. In an exemplary embodiment, second U-shaped part 422 may include a first slot 426 and third U-shaped part 424 may include a second slot 428. In an exemplary embodiment, first slot 426 and second slot 428 may be aligned with each other along an axis perpendicular to both normal axis 412 and longitudinal axes of first extended tongue 418 and second extended tongue 420. In an exemplary embodiment, such alignment of first slot 426 and second slot 428 may form an elongated slot on a second opposing side of middle member 406 perpendicular to first groove 408 and second groove 410.

In an exemplary embodiment, driven wheel 404 may be a slider slidably disposed within the elongated slot formed by first slot 426 and second slot 428. In an exemplary embodiment, such configuration of driven wheel 404 within the elongated slot formed by first slot 426 and second slot 428 may allow for forming a second tongue-and-groove connector on the second opposing side of middle member 406 perpendicular to the first tongue-and-groove connector.

In an exemplary embodiment, all rotational and translational motions of second pin 326 are restricted by annular sleeve 312, except for rotational motion of second pin 326 about longitudinal axis 328 of second pin 326. Since second pin 326 may not assume any translational movements, responsive to rotational movement of driver wheel 402, middle member 406 my slide along longitudinal axes of first groove 408 and second groove 410 while the elongated slot formed by first slot 426 and second slot 428 may slide around driven wheel 404 urging second pin 326 to rotate about longitudinal axis 328 of second pin 326.

In an exemplary embodiment, actuation assembly 304 may further include a first support wall 384 with a first hole 385 fitted with a second bearing unit 386, a second hole 387 fitted with a third bearing unit 388, and a third hole 389 fitted with a fourth bearing unit 390. In an exemplary embodiment, drive shaft 330 may rotatably pass through first hole 385 leaning on second bearing unit 386, secondary shaft 342 may rotatably pass through second hole 387 leaning on third bearing unit 388, and auxiliary shaft 360 may rotatably pass through third hole 389 leaning on fourth bearing unit 390.

In an exemplary embodiment, actuation assembly 304 may further include a second support wall 391 that may be parallel with first support wall 384. In an exemplary embodiment, second support wall 391 may be spaced apart from first support wall 384 along longitudinal axis 338 of drive shaft 330. In an exemplary embodiment, second support wall 391 may include a fourth hole 392 fitted with a fifth bearing unit 393, a fifth hole 394 fitted with a sixth bearing unit 395, and a sixth hole 396 fitted with a seventh bearing unit 397. In an exemplary embodiment, first spur gear set 344 may be disposed between first support wall 384 and second support wall 391. In an exemplary embodiment, drive shaft 330 may rotatably pass through fourth hole 392 leaning on fifth bearing unit 393, secondary shaft 342 may rotatably pass through fifth hole 394 leaning on sixth bearing unit 395, and auxiliary shaft 360 may rotatably pass through sixth hole 396 leaning on seventh bearing unit 397.

In an exemplary embodiment, actuation assembly 304 may further include a third support wall 398 parallel with second support wall 391. In an exemplary embodiment, third support wall 398 may be spaced apart from second support wall 391 along longitudinal axis 338 of drive shaft 330. In an exemplary embodiment, third support wall 398 may include a seventh hole 399 and an eighth hole 3910 fitted with an eighth bearing unit 3911. In an exemplary embodiment, second spur gear set 346 may be disposed between third support wall 398 and second support wall 391. In an exemplary embodiment, secondary shaft 342 may rotatably pass through eighth hole 3910 leaning on eighth bearing unit 3911. In an exemplary embodiment, first pin 320 and second pin 326 may rotatably pass through seventh hole 399. In an exemplary embodiment, seventh hole 399 may be aligned with central hole 310 of annular friction surface 308 along the normal axis of annular friction surface 308, such that seventh hole 399 and central hole 310 may form one elongated hole, through which first pin 320 and second pin 326 may rotatably pass.

In an exemplary embodiment, seventh hole 399 may include an annular lip 3912 that may extend perpendicular to third support wall 398. In an exemplary embodiment, sixth spur gear 378 may be rotatably mounted on annular lip 3912 utilizing a nineth bearing unit 3913.

In an exemplary embodiment, such configuration of double-pin friction stir device 302 and actuation mechanism 304 may allow for driving the rotational movements of first pin 320 and second pin 326 in opposite directions and driving the rotational movement of annular friction surface 308 by utilizing a single driving source, such as a single spindle. In an exemplary embodiment, exemplary double-pin friction stir device 302 including first pin 320 and second pin 326 in addition to annular tool 306 may form a double-pin and a single shoulder stir configuration, in which first pin 320 and second pin 326 may be as double pins and annular friction surface 308 may function as the single shoulder. In an exemplary embodiment, utilizing such double-pin and a single shoulder stir configuration may allow for performing a friction stir welding process with a tandem contrarotating double-pin configuration, where a distance between the two pins may be kept relatively small.

The foregoing description of the specific embodiments will so fully reveal the general nature of the disclosure that others is, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic, e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

What is claimed is:

1. A double-pin friction stir device, comprising:
an annular tool comprising an annular friction surface, the annular tool comprising a hollow cylinder with an annular ring-shaped cross section, the annular friction surface comprising an annular ring-shaped bottom surface of the hollow cylinder, the annular friction surface comprising a central hole, the annular friction surface configured to rotate about a normal axis of the annular friction surface in a first direction by transferring a rotational movement of a spindle to the annular friction surface;
a first pin having a rod-shape extending through the central hole along the normal axis of the annular friction surface, a distal end of the first pin protruding from the annular friction surface, the first pin configured to rotate about a longitudinal axis of the first pin in the first direction by transferring a rotational movement of a spindle to the first pin; and
a second pin having a rod-shape extending through the central hole along and parallel with the first pin, a distal end of the second pin protruding from the annular friction surface, the second pin configured to rotate about a longitudinal axis of the second pin in a second direction by transferring a rotational movement of a spindle to the second pin, the second direction opposite the first direction.

2. The device of claim 1, the distal end of the first pin and the distal end of the second pin protrude from the annular friction surface by a similar distance.

3. The device of claim 2, further comprising a drive shaft extended along the longitudinal axis of the first pin between a first end of the drive shaft and a second opposing end of the drive shaft, the first end of the drive shaft attached to an opposing proximal end of the first pin, the second end of the drive shaft coupled to the spindle, the drive shaft transferring a rotational movement of the spindle to the first pin about the longitudinal axis of the first pin in the first direction.

4. The device of claim 3, further comprising a secondary shaft extended parallel with the drive shaft, the secondary shaft coupled to the drive shaft utilizing a first spur gear set, the drive shaft further transferring a rotational movement of the spindle to the secondary shaft about a longitudinal axis of the secondary shaft in the first direction, the secondary shaft further coupled with the second pin via a second spur gear set, the secondary shaft driving a rotational movement of the second pin about the longitudinal axis of the second pin in the second direction.

5. The device of claim 4, wherein the secondary shaft is further coupled with the annular friction surface utilizing a third spur gear set, the secondary shaft further driving a rotational movement of the annular friction surface about the normal axis of the annular friction surface in the second direction.

6. The device of claim 5, wherein the first spur gear set comprises:
a first spur gear mounted on the drive shaft, the first spur gear being rotatable with the drive shaft in the first direction;
a second spur gear mounted on the secondary shaft, the second spur gear being rotatable with the secondary shaft; and
a middle gear mounted on an auxiliary shaft, the auxiliary shaft extended along and parallel with the drive shaft, the middle gear being rotatable with the auxiliary shaft about a longitudinal axis of the auxiliary shaft, the middle gear being meshed with both the first spur gear and the second spur gear; the middle gear transferring the rotational movement of the first spur gear to the second spur gear.

7. The device of claim 6, wherein the second spur gear set comprises:
a third spur gear mounted on the secondary shaft, the third spur gear rotatable with the secondary shaft in the first direction; and
a fourth spur gear meshed with the third spur gear, the third spur gear rotating the fourth spur gear in the second direction,
wherein the fourth spur gear is coupled to the second pin, the fourth gear driving a rotational movement of the second pin about the longitudinal axis of the second pin in the second direction.

8. The device of claim 7, wherein the fourth gear is mounted on the drive shaft via a first bearing unit, the first bearing unit allowing the drive shaft to rotatably pass through the fourth spur gear.

9. The device of claim 7, wherein the third spur gear spaced apart from the second spur gear along the longitudinal axis of the secondary shaft.

10. The device of claim 9, wherein the third spur gear set comprises:
a fifth spur gear mounted on the secondary shaft, the fifth spur gear rotatable with the secondary shaft in the first direction, the fifth spur gear spaced apart from the third spur gear along the longitudinal axis of the secondary shaft; and
a sixth spur gear meshed with the fifth spur gear, the sixth spur gear rotatable in the second direction, the sixth spur gear attached to and coaxially rotatable with the annular friction surface.

11. The device of claim 10, wherein the annular tool is coupled with the sixth spur gear, the annular tool rotatable with the sixth spur gear in the second direction.

12. The device of claim 10, wherein the second pin is coupled with the fourth spur gear utilizing a coupling mechanism, the coupling mechanism comprising:
a driver wheel coupled and rotatable with the fourth spur gear, the driver wheel comprising a first groove and a second groove, the first groove and the second groove extended parallel with each other along an axis perpendicular to the normal axis of the fourth spur gear;
a driven wheel comprising a slider attached to the second pin; and
a middle member coupled between the driver wheel and the driven wheel, the middle member transferring the rotational motion of the driver wheel to the driven wheel, the middle member comprising:
a first U-shaped part comprising a first extended tongue slidably disposed within the first groove and a second extended tongue slidably disposed within the second groove;
a second U-shaped part attached to the first U-shaped part, the second U-shaped part comprising a first slot perpendicular to the first extended tongue; and
a third U-shaped part attached to the first U-shaped part, the third U-shaped part comprising a second slot perpendicular to the second extended tongue, the first slot aligned with the second slot forming an elongated slot, the elongated slot being perpendicular to the first groove and the second groove,
wherein the slider slidably disposed within the elongated slot.

13. The device of claim 12, further comprising:
a first support wall comprising a first hole fitted with a second bearing unit, a second hole fitted with a third bearing unit, and a third hole fitted with a fourth bearing unit, the drive shaft rotatably passing through the first hole leaning on the second bearing unit, the secondary shaft rotatably passing through the second hole leaning on the third bearing unit, and the auxiliary shaft rotatably passing through the third hole leaning on the fourth bearing unit.

14. The device of claim 13, further comprising:
a second support wall parallel with the first support wall, the second support wall spaced apart from the first support wall along the longitudinal axis of the drive shaft, the second support wall comprising a fourth hole fitted with a fifth bearing unit, a fifth hole fitted with a sixth bearing unit, and a sixth hole fitted with a seventh bearing unit, the drive shaft rotatably passing through the fourth hole leaning on the fifth bearing unit, the secondary shaft rotatably passing through the fifth hole leaning on the sixth bearing unit, and the auxiliary shaft rotatably passing through the sixth hole leaning on the seventh bearing unit.

15. The device of claim 14, further comprising:
a third support wall parallel with the second support wall, the third support wall spaced apart from the second support wall along the longitudinal axis of the drive shaft, the third support wall comprising a seventh hole and an eighth hole fitted with an eighth bearing unit, the secondary shaft rotatably passing through the eighth hole leaning on the eighth bearing unit, the first pin and the second pin rotatably passing through the seventh hole, the seventh hole aligned with the central hole of the annular friction surface along the normal axis of the annular friction surface.

16. The device of claim 15, wherein the first spur gear set is disposed between the first support wall and the second support wall, and wherein the second spur gear set is disposed between the third support wall and the second support wall.

17. The device of claim 16, wherein the seventh hole comprises an annular lip extended perpendicular to the third support wall, the seventh spur gear rotatably mounted on the annular lip.
